(19) United States
(12) Patent Application Publication
(10) Pub. No.: US 2026/0178032 A1
(43) Pub. Date: Jun. 25, 2026

(54) INFORMATION OUTPUT METHOD, INFORMATION OUTPUT DEVICE, AND NON-TRANSITORY COMPUTER-READABLE RECORDING MEDIUM

(71) Applicant: Panasonic Intellectual Property Management Co., Ltd., Osaka (JP)

(72) Inventors: Masaaki ENDO, Tokyo (JP); Shunsuke KUHARA, Osaka (JP); Masaki SATO, Tokyo (JP)

(21) Appl. No.: 19/423,177

(22) Filed: Dec. 17, 2025

Related U.S. Application Data
(63) Continuation of application No. PCT/JP2024/023646, filed on Jun. 28, 2024.

(30) Foreign Application Priority Data
Jul. 5, 2023 (JP) 2023-111066

(51) Int. Cl. G05D 1/227; G08G 1/01

(52) U.S. Cl. CPC G05D 1/227; G08G 1/0125

(57) ABSTRACT

An information output method includes: obtaining following state information related to a following state of a mobile body that is autonomously movable and remotely controllable for movement; calculating a traffic congestion resolution timing that indicates when a traffic congestion is to be resolved, the traffic congestion resolution timing being identified based on the following state information; and notifying mobile body information to an outside from the mobile body, the mobile body information including information related to the traffic congestion resolution timing.

### CROSS REFERENCE TO RELATED APPLICATIONS

This is a continuation application of PCT International Application No. PCT/JP 2024/023646 filed on Jun. 28, 2024, designating the United States of America, which is based on and claims priority of Japanese Patent Application No. 2023-111066 filed on Jul. 5, 2023. The entire disclosures of the above-identified applications, including the specifications, drawings and claims are incorporated herein by reference in their entirety.

### FIELD

The present disclosure relates to an information output method, an information output device, and a non-transitory computer-readable recording medium that output information related to a mobile body that is autonomously movable and remotely controllable.

### BACKGROUND

Methods of remotely controlling mobile bodies are conventionally known (see, for example, Patent Literatures (PTLs) 1 and 2).

### CITATION LIST

### Patent Literature

PTL 1: Japanese Unexamined Patent Application Publication No. 2020-005123

PTL 2: Japanese Unexamined Patent Application Publication (Translation of PCT Application) No. 2020-530618

### SUMMARY

### Technical Problem

When a traffic congestion occurs due to an autonomously movable and remotely controllable mobile body, there are instances where a person around the mobile body is unable to take appropriate action against the traffic congestion if the person does not know when the traffic congestion will be resolved.

In view of the above, the present disclosure provides an information output method, an information output device, and a non-transitory computer-readable recording medium that, when a traffic congestion occurs due to an autonomously movable and remotely controllable mobile body, enable a person around the mobile body to know when the traffic congestion will be resolved.

### Solution to Problem

An information output method according to one aspect of the present disclosure includes: obtaining following state information related to a following state of a mobile body that is autonomously movable and remotely controllable for movement; calculating a traffic congestion resolution timing that indicates when a traffic congestion is to be resolved, the traffic congestion resolution timing being identified based on the following state information; and notifying mobile body information to an outside from the mobile body, the mobile body information including information related to the traffic congestion resolution timing.

It should be noted that, in this Specification, a traffic congestion refers to a state in which, due to a presence of a mobile body, a following mobile body that is following the mobile body is unable to pass around the mobile body.

An information output device according to one aspect of the present disclosure includes: a following state information obtainer that obtains following state information related to a following state of a mobile body that is autonomously movable and remotely controllable for movement; a calculator that calculates a traffic congestion resolution timing that indicates when a traffic congestion is to be resolved, the traffic congestion resolution timing being identified based on the following state information; and a notification information outputter that notifies mobile body information to an outside from the mobile body, the mobile body information including information indicating the traffic congestion resolution timing.

A non-transitory computer-readable recording medium according to one aspect of the present disclosure is a non-transitory computer-readable recording medium having a program recorded thereon for causing a computer to perform information output processing, and the information output processing includes: obtaining following state information related to a following state of a mobile body that is autonomously movable and remotely controllable for movement; calculating a traffic congestion resolution timing that indicates when a traffic congestion is to be resolved, the traffic congestion resolution timing being identified based on the following state information; and notifying mobile body information to an outside from the mobile body, the mobile body information including information indicating the traffic congestion resolution timing.

### Advantageous Effects

With an information output method, an information output device, and a non-transitory computer-readable recording medium according to the present disclosure, when a traffic congestion occurs due to an autonomously movable and remotely controllable mobile body, it is possible for a person around the mobile body to know when the traffic congestion will be resolved.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 s a block diagram illustrating a configuration of a remote control system according to Embodiment 1.

FIG. 2A is a schematic diagram illustrating an example of an image indicating mobile body information displayed, on a display, by a notifying section according to Embodiment 1.

FIG. 2B is a schematic diagram illustrating an example of the image indicating the mobile body information displayed, on the display, by the notifying section according to Embodiment 1.

FIG. 2C is a schematic diagram illustrating an example of the image indicating the mobile body information displayed, on the display, by the notifying section according to Embodiment 1.

FIG. 2D is a schematic diagram illustrating an example of the image indicating the mobile body information displayed, on the display, by the notifying section according to Embodiment 1.

FIG. 3 is a schematic diagram illustrating an example of the state in which a determiner according to Embodiment 1 determines whether a traffic congestion related to mobile body is present.

FIG. 4A is a schematic diagram illustrating an example of the state in which a calculator according to Embodiment 1 calculates a traffic congestion resolution timing.

FIG. 4B is a schematic diagram illustrating another example of the state in which the calculator according to Embodiment 1 calculates a traffic congestion resolution timing.

FIG. 5A is a schematic diagram illustrating an example of an image indicating overtaking remote control information and/or remote control request information that a remote control information outputter according to Embodiment 1 displays on the display.

FIG. 5B is a schematic diagram illustrating an example of the image indicating the overtaking remote control information and/or the remote control request information that the remote control information outputter according to Embodiment 1 displays on the display.

FIG. 6 is a flowchart illustrating following state information transmission processing performed by the mobile body according to Embodiment 1.

FIG. 7 is a flowchart illustrating the remote control request processing performed by the mobile body according to Embodiment 1.

FIG. 8 is a flowchart illustrating notification processing performed by the mobile body according to Embodiment 1.

FIG. 9 is a flowchart illustrating the first notification information output processing performed by a control center according to Embodiment 1.

FIG. 10 is a flowchart illustrating remote control processing performed by the control center according to Embodiment 1.

FIG. 11 s a block diagram illustrating a configuration of a remote control system according to Embodiment 2.

FIG. 12 is a flowchart illustrating the second notification information output processing performed by a control center according to Embodiment 2.

FIG. 13 is a flowchart illustrating inquiry processing performed by the control center according to Embodiment 2.

FIG. 14 is a flowchart illustrating the first determination processing performed by the control center according to Embodiment 2.

FIG. 15 is a flowchart illustrating the second determination processing performed by the control center according to Embodiment 2.

FIG. 16 is a flowchart illustrating the third determination processing performed by the control center according to Embodiment 2.

### DESCRIPTION OF EMBODIMENTS

### (Circumstances Leading to One Aspect of the Present Disclosure)

Conventionally, when a traffic congestion occurs due to an unmanned mobile body, it is sometimes difficult for a person around the unmanned mobile body to determine how to take action against the traffic congestion.

The inventors have considered that in such a case, if the person around the mobile body could know when the traffic congestion would be resolved, the person would be able to take appropriate action against the traffic congestion.

On the basis of this concept, the inventors have diligently and repeatedly carried out experiments and studies, and arrived at an information output method, an information output device, and a non-transitory computer-readable recording medium according to the present disclosure described below.

The information output method according to one aspect of the present disclosure includes: obtaining following state information related to a following state of a mobile body that is autonomously movable and remotely controllable for movement; calculating a traffic congestion resolution timing that indicates when a traffic congestion is to be resolved, the traffic congestion resolution timing being identified based on the following state information; and notifying mobile body information to an outside from the mobile body, the mobile body information including information related to the traffic congestion resolution timing.

According to the above-described information output method, it is possible for a person around the mobile body to know when the traffic congestion will be resolved, by being notified of notification information from the mobile body. As a result, the person around the mobile body is capable of taking an appropriate action against the traffic congestion.

In addition, the information output method may further include: obtaining a remote control request that requests remote control of the mobile body; and when the remote control request is obtained in the obtaining of the remote control request, outputting overtaking remote control information to the outside, the overtaking remote control information being for remotely controlling the mobile body to enable a following mobile body that is following the mobile body to overtake the mobile body.

In this manner, when (i) a remote control request has been issued and (ii) a traffic congestion is occurring, an operator who remotely controls the mobile body can remotely control the mobile body based on overtaking remote control information so as to enable a following mobile body to overtake the mobile body.

In addition, the outputting may further include, when the remote control request is obtained in the obtaining of the remote control request, outputting remote control request information to the outside, the remote control request information being for remotely controlling the mobile body to cause the mobile body to move according to the remote control request.

In this manner, when a remote control request has been issued, the operator who remotely controls the mobile body can remotely controls the mobile body based on overtaking remote control information so as to cause the mobile body to move according to the remote control request.

In addition, in the outputting, at least during a period in which the overtaking remote control information is being output, the outputting of the remote control request information may be inhibited.

In this manner, when (i) a remote control request has been issued and (ii) a traffic congestion is occurring, it is possible to inhibit the operator who remotely controls the mobile body from remotely controlling, based on remote control request information, the mobile body to move according to the remote control request.

In addition, in the outputting, when (i) the remote control request is obtained in the obtaining of the remote control request and (ii) the following mobile body satisfies a predetermined condition, the outputting of the overtaking remote control information may be inhibited.

In this manner, when the following mobile body is a mobile body that satisfies a predetermined condition, it is possible to inhibit the operator who remotely controls a mobile body from remotely controlling, based on the overtaking remote control information, the mobile body to cause the mobile body to move according to the remote control request.

In addition, the outputting may further include, when outputting both the overtaking remote control information and the remote control request information, outputting priority information to the outside, the priority information indicating that remote control according to the overtaking remote control information takes priority over remote control according to the remote control request information.

In this manner, the operator who remotely controls the mobile body can remotely control the mobile body giving more priority to the remote control according to the overtaking remotely control information than to the remote control according to the remote control request information.

In addition, in the outputting, when the following mobile body is an emergency vehicle, the outputting of the remote control request information may be inhibited while the overtaking remote control information is output to the outside.

In this manner, when the following mobile body is an emergency vehicle, it is possible to inhibit the operator who remotely controls a mobile body from remotely controlling, based on the remote control request information, the mobile body to cause the mobile body to move according to the remote control request information.

In addition, in the outputting, when the following mobile body is a predetermined priority mobile body that is defined by a rule, the outputting of the remote control request information may be inhibited.

In this manner, when the following mobile body is a priority mobile body, it is possible to inhibit the operator who remotely controls a mobile body from remotely controlling, based on the remote control request information, the mobile body to cause the mobile body to move according to the remote control request information.

In addition, in the outputting, when the following mobile body is a predetermined non-priority mobile body that is defined by a rule, the outputting of the overtaking remote control information may be inhibited.

In this manner, when the following mobile body is a non-priority mobile body, it is possible to inhibit the operator who remotely controls a mobile body from remotely controlling, based on the overtaking remote control information, the mobile body to cause the mobile body to move according to the overtaking remote control request information.

In addition, the outputting may further include, when (i) remote control of the mobile body that is performed in response to the outputting of the overtaking remote control information has ended and (ii) remote control of the mobile body that is performed in response to the outputting of the remote control request information has not yet started, outputting information indicating that the remote control of the mobile body that is performed in response to the outputting of the remote control request information has not yet started, to the outside.

In this manner, it is possible to notify the operator who remotely controls a mobile body of the fact that the remote control of the mobile body that is performed in response to the outputting of the remote control request information has not yet started.

In addition, the outputting may further include, when (i) remote control of the mobile body that is performed in response to the outputting of the overtaking remote control information has ended and (ii) remote control of the mobile body that is performed in response to the outputting of the remote control request information has not yet started, outputting information indicating making an inquiry as to whether the remote control of the mobile body that is performed in response to the outputting of the remote control request information is to be performed prior to remote control of an other mobile body than the mobile body, to the outside.

In this manner, it is possible to cause the operator who remotely controls a mobile body to determine whether to perform the remote control of the mobile body that is performed in response to the outputting of the remote control request information that has not yet been performed, prior to remote control of another mobile body.

In addition, in the outputting, the outputting of the remote control request information may be inhibited until remote control of the mobile body that is performed in response to the outputting of the overtaking remote control information is completed.

In this manner, it is possible to inhibit the operator who remotely controls a mobile body from remotely controlling the mobile body to cause the mobile body to move according to the remote control request information, before the remote control of the mobile body that is performed in response to the outputting of the overtaking remote control information is completed.

In addition, the information output method may further include: determining whether a traffic congestion related to the mobile body is present, based on the following state information. In the information output method, the outputting may further include, when it is determined in the determining that the traffic congestion is present during a period in which remote control of the mobile body that is performed in response to the outputting of the remote control request information is being performed, outputting at least one of the overtaking remote control information or the remote control request information, to the outside, in a manner corresponding to progress of the remote control.

In this manner, it is possible to remotely control a mobile body to cause the mobile body to move according to remote control request information and/or overtaking remote control information, according to the progress of remote control of the mobile body that is performed in response to the outputting of the remote control request information.

An information output device according to one aspect of the present disclosure includes: a following state information obtainer that obtains following state information related to a following state of a mobile body that is autonomously movable and remotely controllable for movement; a calculator that calculates a traffic congestion resolution timing that indicates when a traffic congestion is to be resolved, the traffic congestion resolution timing being identified based on the following state information; and a notification information outputter that notifies mobile body information to an outside from the mobile body, the mobile body information including information indicating the traffic congestion resolution timing.

According to the above-described information output device, it is possible for a person around the mobile body to know when the traffic congestion will be resolved, by receiving the notification information that is notified from the mobile body. As a result, the person around the mobile body is capable of taking an appropriate action against the traffic congestion.

A non-transitory computer-readable recording medium according to one aspect of the present disclosure is a non-transitory computer-readable recording medium having a program recorded thereon for causing a computer to perform information output processing, and the information output processing includes: obtaining following state information related to a following state of a mobile body that is autonomously movable and remotely controllable for movement; calculating a traffic congestion resolution timing that indicates when a traffic congestion is to be resolved, the traffic congestion resolution timing being identified based on the following state information; and notifying mobile body information to an outside from the mobile body, the mobile body information including information indicating the traffic congestion resolution timing.

According to the above-described non-transitory computer-readable recording medium, it is possible for a person around the mobile body to know when the traffic congestion will be resolved, by receiving the notification information that is notified from the mobile body. As a result, the person around the mobile body is capable of taking an appropriate action against the traffic congestion.

Hereinafter, specific examples of a remote control system according to one aspect of the present disclosure will be described with reference to the drawings. Each of the embodiments described here shows one specific example of the present disclosure. The numerical values, shapes, structural elements, the arrangement and connection of the structural elements, steps (processes), and the processing order of the steps, for instance, described in the following embodiments are mere examples, and thus are not intended to limit the scope of the present disclosure. In addition, each diagram is a schematic diagram and not necessarily strictly illustrated. Throughout the drawings, the same numeral is given to substantially the same structural component, and redundant description will be omitted or simplified.

### Embodiment 1

Hereinafter, a remote control system according to Embodiment 1 which remotely controls at least one mobile body is to be described.

### (Configuration)

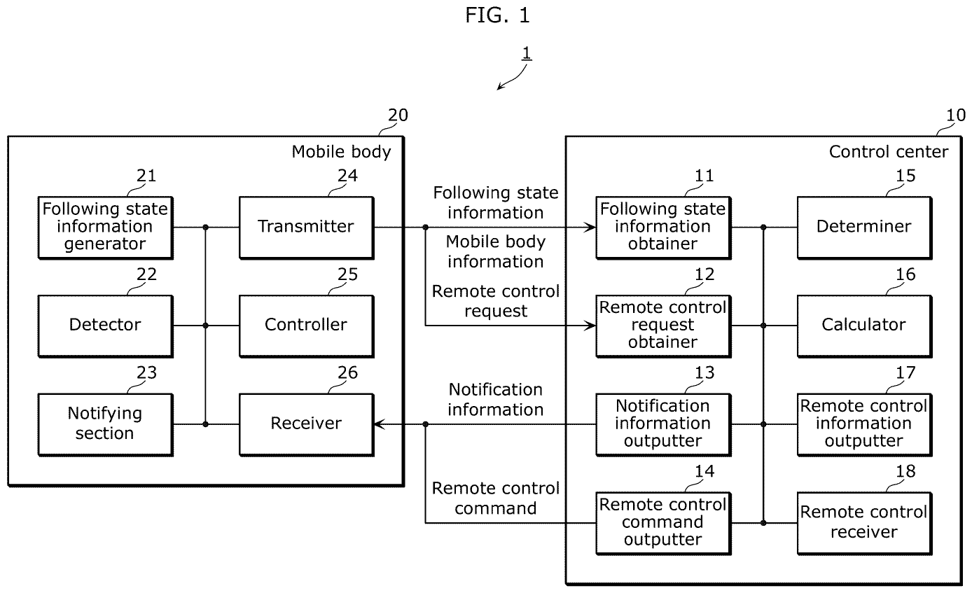

FIG. 1 s a block diagram illustrating a configuration of remote control system 1 according to Embodiment 1.

As illustrated in FIG. 1, remote control system 1 includes control center 10 and mobile body 20. In FIG. 1, remote control system 1 is illustrated as if remote control system 1 includes only one mobile body 20. However, a total number of mobile bodies 20 included in remote control system 1 is not necessarily limited to one. Two or more mobile bodies 20 may be included in remote control system 1. Here, the description will be provided assuming that remote control system 1 includes a plurality of mobile bodies 20.

Mobile body 20 is an autonomously movable mobile body. When mobile body 20 receives a remote control command transmitted from control center 10 while mobile body 20 is autonomously moving, mobile body 20 temporarily suspends autonomous movement and moves according to the remote control command. In other words, mobile body 20 is a mobile body that is autonomously movable and remotely controllable for movement.

Mobile body 20 may be, for example, an automobile that travels on a public road, or may be, for example, a robot that moves on a manufacturing floor in a factory and is capable of transporting components.

As illustrated in FIG. 1, mobile body 20 includes following state information generator 21, detector 22, notifying section 23, transmitter 24, controller 25, and receiver 26.

Following state information generator 21, detector 22, notifying section 23, transmitter 24, controller 25, and receiver 26 may be implemented in a computer including, for example, a processor (e.g., a central processing unit (CPU)), memory, various communication interfaces, and various input/output interfaces, by the processor executing a program stored in the memory.

Controller 25 controls the autonomous movement of mobile body 20.

In the case where controller 25 controls the autonomous movement of mobile body 20, when receiver 26 which will be described later receives a remote control command from control center 10, controller 25 temporarily suspends the autonomous movement of mobile body 20 and controls the movement of mobile body 20 according to the remote control command.

Controller 25 generates a remote control request that requests remote control, to control center 10. In this case, controller 25 may generate a remote control request to request remote control to control center 10, for example, upon falling in a state in which the autonomous movement of mobile body 20 is difficult.

The state in which the autonomous movement of mobile body 20 is difficult refers to a state such as when mobile body 20 cannot move straight ahead due to an obstacle that is present in front of mobile body 20. In this Specification, the state in which the autonomous movement of mobile body 20 is difficult is also referred to as a stuck state, and mobile body 20 falling into a stuck state is also referred to as being stuck.

It should be noted that controller 25 may inhibit the generation of a remote control request when a traffic congestion is expected to occur as a result of temporarily suspending mobile body 20 for switching from the autonomous movement control of mobile body 20 to remote control from control center 10. In this manner, it is possible to inhibit the occurrence of a traffic congestion resulting from the temporarily suspending mobile body 20 at the time of switching from the autonomous movement to remote control of mobile body 20.

In this case, controller 25 may generate a remote control request after mobile body 20 has moved to a location where a traffic congestion is not expected to occur due to the temporarily suspending of mobile body 20.

Detector 22 detects a following mobile body that is following mobile body 20.

The following mobile body may be, for example, an automobile, a bicycle, a robot, or a person.

Detector 22 may include, for example, a camera and/or a light detection and ranging (LiDAR), and detect a following mobile body by performing object detection processing that uses the camera and/or the LiDAR.

Detector 22, for example, may detect a shape of the following mobile body, a distance to the following mobile body, or a speed of the following mobile body.

In addition, for example, detector 22 may detect a vehicle type when the following mobile body is an automobile, detect a product number when the following mobile body is a robot, or detect whether the following mobile body is a specific person when the following mobile body is a person.

Following state information generator 21 generates, based on the detection performed by detector 22, following state information related to a following state of mobile body 20.

The following state information, for example, may include information indicating the shape of the following mobile body, information indicating the distance to the following mobile body, information indicating the speed of the following mobile body, information indicating the vehicle type of the following mobile body, information indicating the product number of the following mobile body, information indicating whether the following mobile body is a specific person, or information indicating the speed of mobile body 20.

The following state information may further include, in addition to the information related to the following state of mobile body 20, for example, obstacle information indicating the location and shape of an obstacle when the obstacle is present in front of mobile body 20, road width information indicating a width of the road when mobile body 20 is traveling on a road, or travel lane width information indicating a width of a travel lane when mobile body 20 is traveling on the travel lane in a manufacturing floor.

Following state information generator 21 may, for example, generate obstacle information, road width information, and/or travel lane width information, based on information (e.g., an image capturing the area in front of mobile body 20) that is used by controller 25 when controlling autonomous movement.

Transmitter 24 transmits the remote control request generated by controller 25 and the following state information generated by following state information generator 21, to control center 10.

Receiver 26 receives the notification information and the remote control command that are transmitted from control center 10.

The notification information is information for notifying mobile body information to the outside. The mobile body information includes information related to a traffic congestion resolution timing that indicates when a traffic congestion related to mobile body 20 is to be resolved. The notification information includes the mobile body information.

When receiver 26 receives the notification information, notifying section 23 notifies the mobile body information included in the notification information, to the outside.

Notifying section 23: may, for example, include a display and display an image indicating mobile body information on the display; may, for example, include a loudspeaker and output audio indicating mobile body information from the loudspeaker; or may, for example, use both of the display and the loudspeaker.

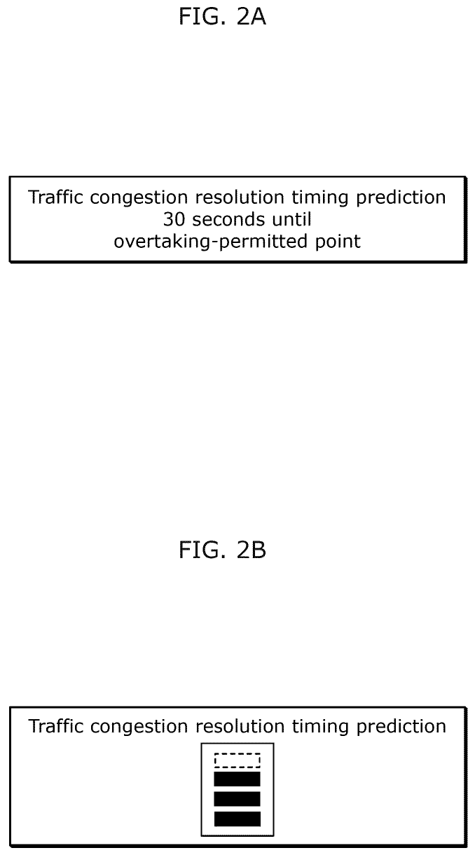

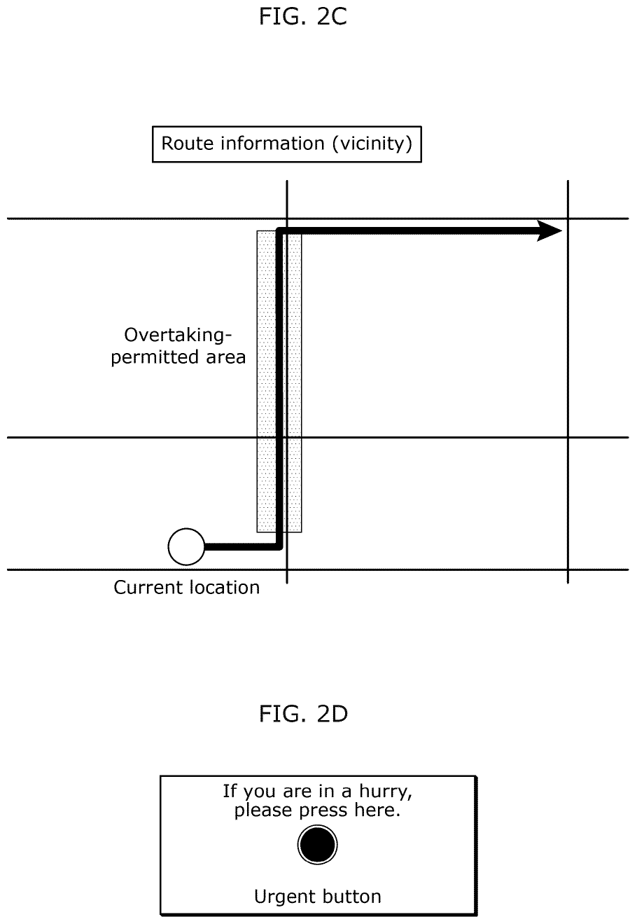

FIGS. 2A, 2B, 2C, and 2D are schematic diagrams illustrating examples of images indicating mobile body information displayed by notifying section 23 on the display.

As illustrated in FIG. 2A and FIG. 2B, notifying section 23 may, for example, display an image indicating a remaining time before the traffic congestion resolution timing, on the display.

In addition, as illustrated in FIG. 2C, notifying section 23 may, for example, display an image on the display indicating a travel route of mobile body 20 during a time period including the traffic congestion resolution timing, thereby prompting a person around mobile body 20 to take a detour from the travel route of mobile body 20. In this case, as illustrated in FIG. 2C, for example, an overtaking-permitted area where the following mobile body can overtake mobile body 20 may be superimposed on the travel route to be displayed.

In addition, as illustrated in FIG. 2D, notifying section 23 may, for example, display an image, on the display, for receiving an operation indicating a request to expedite resolving of the traffic congestion, from a person around mobile body 20.

In this case, for example, notifying section 23: may include a physical button and receive an operation performed using the physical button; may include a touch panel and receive an operation performed using the buttons displayed on the touch panel; may include a voice input device and receive an input operation using voice recognition; may include a camera and receive an input operation using gesture recognition; or may receive an input operation using an application installed on a smartphone, or the like.

In addition, in this case, for example, notifying section 23: may include a camera and, by using face recognition, vehicle number recognition, etc., receive an input operation only when the input operation is made by a specific person; or may include a contactless card reader, a tag reader, etc., and, by using the ID read from the contactless card, tag, etc., receive an input operation only when the input operation is made by a specific person.

In addition, when notifying section 23 receives an operation indicating a request to expedite resolving of the traffic congestion from a person around mobile body 20, for example, transmitter 24 may transmit, to control center 10, urgent information indicating that the operation indicating the request to expedite resolving of the traffic congestion has been received.

In addition, although not illustrated in FIG. 2A to FIG. 2D, notifying section 23 may display, on the display, an image indicating a route that allows a following mobile body to take a detour.

In this case, notifying section 23 may further display, on the display, an image indicating a distance and/or a time until the following mobile body starts rerouting.

Returning to FIG. 1, the following continues to describe remote control system 1.

Control center 10 remotely controls a plurality of mobile bodes 20.

One or more operators who remotely control mobile body 20 are arranged at control center 10. Each operator is assigned with a plurality of mobile bodies 20 which are targets of remote control. Each operator remotely controls the plurality of mobile bodies 20 assigned, by operating remote control receiver 18 (described later) included in control center 10.

As illustrated in FIG. 1, control center 10 includes: following state information obtainer 11; remote control request obtainer 12; notification information outputter 13; remote control command outputter 14; determiner 15; calculator 16; remote control information outputter 17; and remote control receiver 18.

Following state information obtainer 11, remote control request obtainer 12, notification information outputter 13, remote control command outputter 14, determiner 15, calculator 16, remote control information outputter 17, and remote control receiver 18 may be implemented, for example, in a computer including a processor (e.g., CPU), memory, various communication interfaces, and various input/output interfaces, by the processor executing a program stored in the memory.

Following state information obtainer 11 obtains following state information transmitted from mobile body 20.

Remote control request obtainer 12 obtains a remote control request transmitted from mobile body 20.

Determiner 15 determines whether a traffic congestion related to mobile body 20 is present, based on the following state information obtained by following state information obtainer 11.

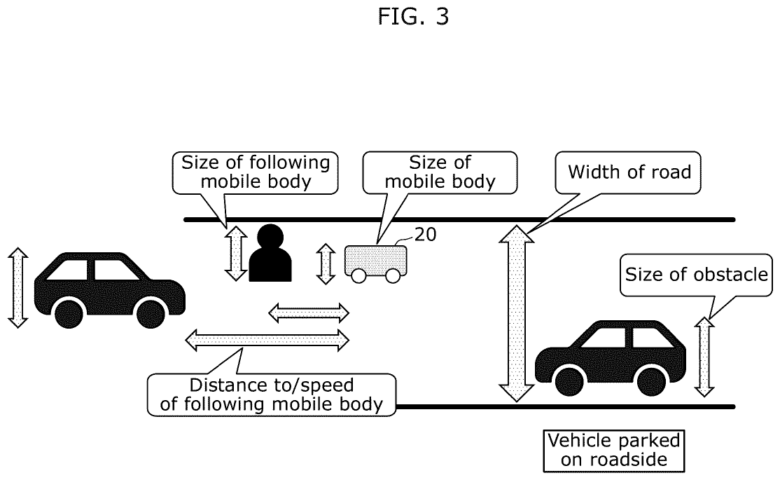

FIG. 3 is a schematic diagram illustrating an example of the state in which determiner 15 determines whether a traffic congestion related to mobile body 20 is present, based on the following state information.

As illustrated in FIG. 3, determiner 15 may determine whether a traffic congestion related to mobile body 20 is present, based on, for example, a size of the following mobile body, a distance to or speed of the following mobile body, a width of the road on which mobile body 20 is traveling, a size of an obstacle that is present in front of mobile body 20, and a size of mobile body 20 stored in advance by determiner 15, which are included in the following state information.

In this case, determiner 15 may determine that a traffic congestion related to mobile body 20 is present when, for example, (width of the road)−(size of the obstacle)−(size of mobile body 20)−(size of the following mobile body)<(first threshold), and (period of duration of following by the following mobile body)>(second threshold).

In addition, determiner 15 may determine whether a traffic congestion related to mobile body 20 is present, based on, for example, the distance to or speed of the following mobile body. In this case, determiner 15 may determine that a traffic congestion related to mobile body 20 is present when, for example, (predicted passage time through a narrow road)>(distance to the following mobile body)/(speed of the following mobile body).

In general, conceivable cases where a traffic congestion occurs due to a factor related to mobile body 20 include: (1) the case where a traffic congestion occurs as a result of mobile body 20 getting stuck (hereinafter also referred to as “first case”), and (2) the case where a traffic congestion occurs as a result of a following mobile body capable of moving at a higher speed than mobile body 20 catching up to mobile body 20 (hereinafter also referred to as “second case”).

Determiner 15 may detect a traffic congestion in the first case, for example, when detector 22 detects a following mobile body after mobile body 20 has stopped due to stuck, and no space is present for the following mobile body to overtake mobile body 20.

In the first case, conceivable patterns of occurrence of a traffic congestion include, for example: a pattern in which a traffic congestion occurs as a result of mobile body 20 getting stuck when a following mobile body is present before mobile body 20 gets stuck; a pattern in which a traffic congestion occurs as a result of mobile body 20 getting stuck and causing a following mobile body to catch up later when no following mobile body was present before mobile body 20 gets stuck.

In addition, determiner 15 may detect a traffic congestion in the second case when, for example, mobile body 20 is in motion, no other mobile body is present in front of mobile body 20, detector 22 detects a following mobile body, the following mobile body is capable of moving at a higher speed than mobile body 20, and no space is present for the following mobile body to overtake mobile body 20.

Returning to FIG. 1, the following continues to describe remote control system 1.

When determiner 15 determines that a traffic congestion related to mobile body 20 is present, calculator 16 calculates a traffic congestion resolution timing that indicates when the traffic congestion related to mobile body 20 will be resolved.

Calculator 16 may calculate the traffic congestion resolution timing, based on, for example, the following state information obtained by following state information obtainer 11, vehicle information indicating various specifications of mobile body 20 stored in advance by calculator 16, and map information including a travel route of mobile body 20 stored in advance by calculator 16.

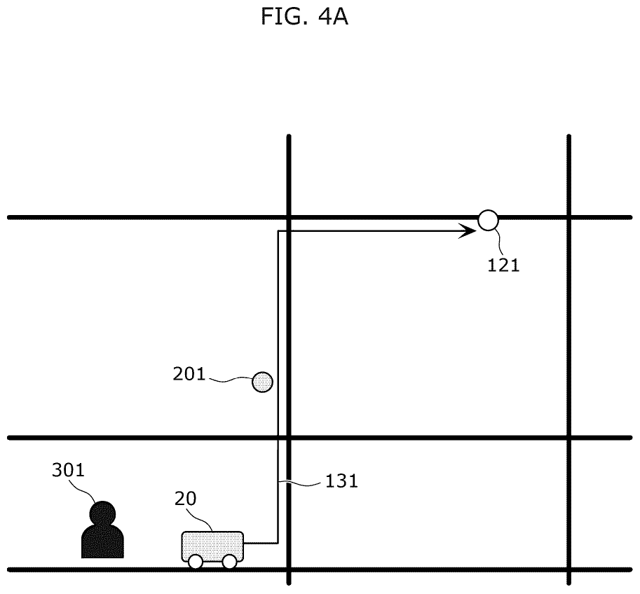

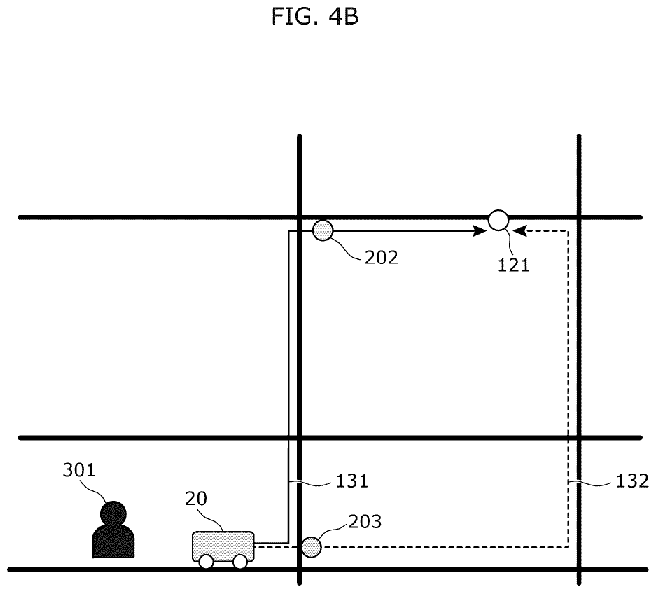

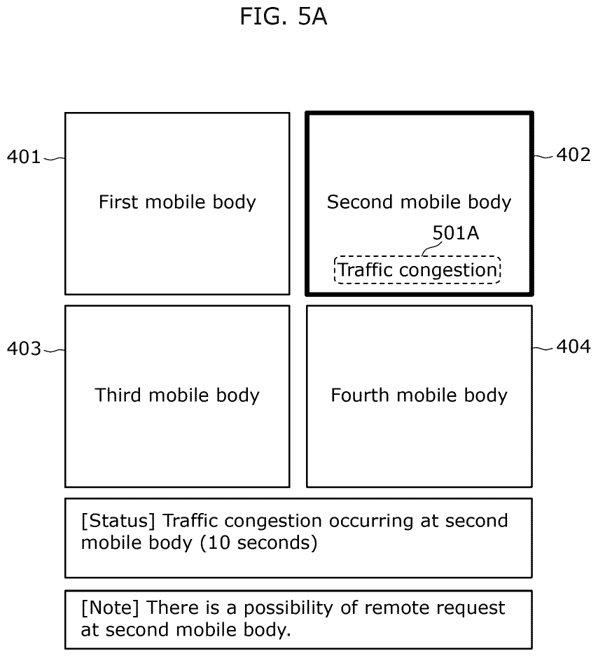

FIG. 4A is a schematic diagram illustrating an example of the state in which calculator 16 calculates a traffic congestion resolution timing.

As illustrated in FIG. 4A, calculator 16 may calculate a traffic congestion resolution timing based on, for example, following state information (e.g., the size of the following mobile body, the distance to the following mobile body, and the speed of the following mobile body), vehicle information (e.g., the size of mobile body 20, the speed of mobile body 20), and map information (e.g., the travel route of mobile body 20, the road width of the travel route).

In this case, calculator 16 may calculate, for example, based on the following state information, the vehicle information, and the map information, predicted traffic congestion resolution point 201 where following mobile body 301 can overtake mobile body 20 on travel route 131 leading to destination 121 of mobile body 20, and calculate a travel time of mobile body 20 to predicted traffic congestion resolution point 201 that has been calculated, as the traffic congestion resolution timing.

FIG. 4B is a schematic diagram illustrating another example of the state in which calculator 16 calculates a traffic congestion resolution timing.

As illustrated in FIG. 4B, calculator 16 may calculate a traffic congestion resolution timing based on, for example, following state information (e.g., the size of the following mobile body, the distance to the following mobile body, and the speed of the following mobile body), vehicle information (e.g., the size of mobile body 20, the speed of mobile body 20), and map information (e.g., destination 121 of mobile body 20, the travel route of mobile body 20, and the road width of roads in proximity to destination 121 including the road width of the travel route).

In this case, calculator 16 calculates, for example, based on the following state information, the vehicle information, and the map information, predicted traffic congestion resolution point 202 where following mobile body 301 can overtake mobile body 20 on travel route 131 leading to destination 121, and then calculates travel time T1 of mobile body 20 to predicted traffic congestion resolution point 202 that has been calculated.

Next, calculator 16 determines whether travel time T1 that has been calculated is greater than or equal to a predetermined threshold. When travel time T1 is greater than or equal to the predetermined threshold, calculator 16 searches for alternative travel route 132 that is other than travel route 131 and leads to destination 121 of mobile body 20. Calculator 16 then calculates predicted traffic congestion resolution point 203 where following mobile body 301 can overtake mobile body 20 on alternative travel route 132 that has been searched for, and calculates travel time T2 of mobile body 20 to predicted traffic congestion resolution point 203 that has been calculated.

Next, calculator 16 may determine whether travel time T2 is less than travel time T1. When travel time T2 is less than travel time T1, calculator 16 may calculate travel time T2 as a traffic congestion resolution timing. When travel time T2 is greater than or equal to travel time T1, calculator 16 may calculate travel time T1 as a traffic congestion resolution timing.

When the traffic congestion resolution timing is calculated, calculator 16 generates notification information that is information for notifying mobile body information, to the outside. The mobile body information includes information related to the traffic congestion resolution timing that has been calculated. The notification information includes the mobile body information.

It should be noted that, here, although the method of resolving a traffic congestion has been described taking as an example the case where a traffic congestion is resolved as a result of following mobile body 301 overtaking mobile body 20, the method of resolving a traffic congestion is not necessarily limited to the case where a traffic congestion is resolved as a result of following mobile body 301 overtaking mobile body 20.

Other examples of the method of resolving a traffic congestion may include: for example, a method of resolving a traffic congestion by increasing the speed of mobile body 20; or for example, when mobile body 20 is a robot capable of transporting components while moving on a manufacturing floor in a factory, a method of resolving a traffic congestion by calling a security personnel of the factory to move an obstacle from the travel route of mobile body 20 by the security personnel.

In addition, here, although the traffic congestion resolution timing has been described taking as an example the case where the traffic congestion resolution timing is the travel time of mobile body 20 to the point where following mobile body 301 can overtake mobile body 20, the traffic congestion resolution timing is not necessarily limited to the case where the traffic congestion resolution timing is the travel time of mobile body 20 to the point where following mobile body 301 can overtake mobile body 20.

Other examples of the traffic congestion resolution timing include the following examples. When mobile body 20 is an automobile traveling on a road, the traffic congestion resolution timing may be the time taken to move mobile body 20 to the shoulder. When mobile body 20 is a robot that delivers a package, for example, the traffic congestion resolution timing may be the time spent waiting for a user to receive the package when the robot waits for the user to receive the package. When the operator who remotely controls mobile body 20 cannot immediately perform the remote control, for example, the traffic congestion resolution timing may be the waiting time until the remote control is started. When the operator who remotely controls mobile body 20 requires preparation time (e.g., time for the operator to confirm the surroundings of mobile body 20 using video information or the like) before starting the remote control, for example, the traffic congestion resolution timing may be the preparation time. When mobile body 20 is a robot capable of transporting components while moving on a manufacturing floor in a factory, for example, the traffic congestion resolution timing may be the time taken to call a security personnel of the factory and for the security personnel to arrive at the location where mobile body 20 is present, or the time taken for the security personnel to move mobile body 20 to an appropriate position.

Returning to FIG. 1, the following continues to describe remote control system 1.

Remote control information outputter 17 outputs, to the outside, overtaking remote control information for remotely controlling mobile body 20 such that a following mobile body that is following mobile body 20 can overtake mobile body 20 when determiner 15 determines that a traffic congestion related to mobile body 20 is present.

In addition, when remote control request obtainer 12 obtains a remote control request for mobile body 20, remote control information outputter 17 outputs, to the outside, remote control request information for remotely controlling mobile body 20 so as to cause mobile body 20 to move according to the remote control request.

In the description here, remote control information outputter 17 outputs the overtaking remote control information and the remote control request information to an operator positioned at control center 10 who remotely controls a plurality of mobile bodies.

It should be noted that the overtaking remote control information, for example, may be generated by determiner 15 or may be generated by remote control information outputter 17.

In addition, the remote control request information, for example, may be generated by remote control request obtainer 12 or may be generated by remote control information outputter 17.

Remote control information outputter 17 may, for example, include a display and display an image indicating overtaking remote control information and/or remote control request information on the display. Alternatively, remote control information outputter 17 may, for example, include a loudspeaker and output audio indicating overtaking remote control information and/or remote control request information from the loudspeaker. Alternatively, for example, both of the display and the loudspeaker may be used.

Here, remote control information outputter 17 is to be explained as including a display and displaying an image indicating overtaking remote control information and/or remote control request information on the display.

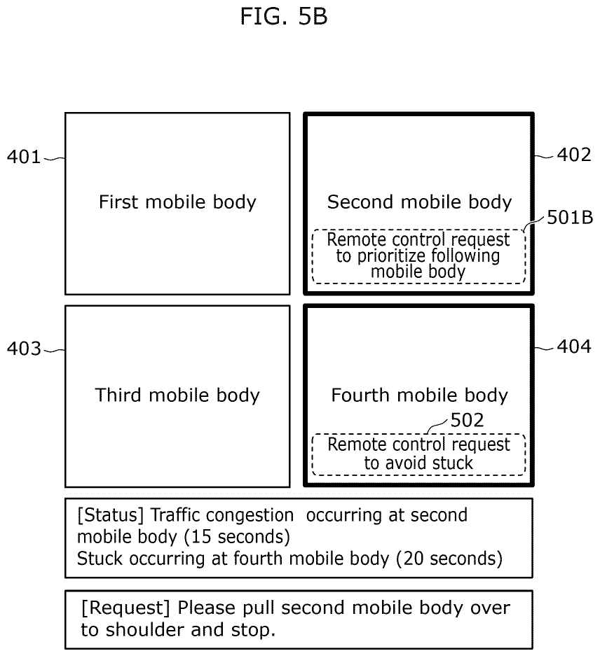

FIG. 5A and FIG. 5B are each a schematic diagram illustrating an example of an image indicating overtaking remote control information and/or remote control request information that remote control information outputter 17 displays on the display.

As illustrated in FIG. 5A, for an image including, for example, first display region 401 where an image related to first mobile body 20A is displayed, second display region 402 where an image related to second mobile body 20B is displayed, third display region 403 where an image related to third mobile body 20C is displayed, and fourth display region 404 where an image related to fourth mobile body 20D is displayed, when determiner 15 determines that a traffic congestion related to second mobile body 20B is present, remote control information outputter 17 may display, in second display region 402, overtaking remote control information 501A to the operator for remotely controlling second mobile body 20B such that a following mobile body that is following second mobile body 20B can overtake second mobile body 20B.

The example illustrated in FIG. 5A shows an example where overtaking remote control information 501A is a character string of “Traffic congestion”. This character string of “Traffic congestion” is an example of a character string displayed when, for example, determiner 15 determines that a traffic congestion is present related to second mobile body 20B in the case where remote control request obtainer 12 has not obtained a remote control request from second mobile body 20B.

As illustrated in FIG. 5B, for an image including, for example, first display region 401 where an image related to first mobile body 20A is displayed, second display region 402 where an image related to second mobile body 20B is displayed, third display region 403 where an image related to third mobile body 20C is displayed, and fourth display region 404 where an image related to fourth mobile body 20D is displayed, (i) when determiner 15 determines that a traffic congestion related to second mobile body 20B is present, remote control information outputter 17 may display, in second display region 402, overtaking remote control information 501B to the operator for remotely controlling second mobile body 20B such that a following mobile body that is following second mobile body 20B can overtake second mobile body 20B, and (ii) when remote control request obtainer 12 obtains a remote control request related to fourth mobile body 20D, remote control information outputter 17 may display, in fourth display region 404, remote control request information 502 to the operator for remotely controlling fourth mobile body 20D so as to cause fourth mobile body 20D to move according to the remote control request.

The example illustrated in FIG. 5B is an example in the case where overtaking remote control information 501B is the character string of “Remote control request to prioritize following mobile body” and remote control request information 502 is the character string of “Remote control request to avoid stuck”. This character string of “Remote control request to prioritize following mobile body” is, for example, an example of a character string that is displayed when determiner 15 determines that a traffic congestion is present related to second mobile body 20B in the case where a remote control request has been obtained by remote control request obtainer 12 from second mobile body 20B, and is displayed when causing the operator to prioritize enabling the following mobile body to overtake mobile body 20 over the remote control request.

It should be noted that the overtaking remote control information may include information indicating the travel route of mobile body 20 during the remote control, and the remote control request information may include information indicating the travel route of mobile body 20 during the remote control.

Here, it has been described that remote control information outputter 17 outputs overtaking remote control information to the outside when determiner 15 determines that a traffic congestion related to mobile body 20 is present. However, when the traffic congestion occurring is a traffic congestion of the second case, even if determiner 15 determines that a traffic congestion related to mobile body 20 is present, there are cases where it is not necessarily required to cause the following mobile body to overtake mobile body 20, and mobile body 20 may continue moving as is. Therefore, in such cases, even if determiner 15 determines that a traffic congestion related to mobile body 20 is present, remote control information outputter 17 does not necessarily have to output the overtaking remote control information to the outside.

Examples of the conceivable case where it is not necessarily required to cause the following mobile body to overtake mobile body 20, and where mobile body 20 may continue moving as is include: the case where, for example, an overtaking-permitted area is not present in a relatively close location; the case where, for example, the distance to the overtaking-permitted area is relatively long; the case where, for example, it is determined that remotely controlling mobile body 20 to enable the following mobile body to overtake mobile body 20 would cause or increase a delay in a task of mobile body 20; and the case where, for example, the distance to the overtaking-permitted area is relatively short.

In addition, when the traffic congestion occurring is a traffic congestion of the second case, since the travel route of the following mobile body is not necessarily identical to the travel route of mobile body 20, remote control information outputter 17 may determine whether to output overtaking remote control information and/or a timing for outputting overtaking remote control information.

In this case, remote control information outputter 17 may, for example, determine whether to output overtaking remote control information and/or the timing for outputting remote control information, based on whether there is a bypass route along the travel route of mobile body 20.

In this case, remote control information outputter 17 may, for example, avoid outputting the overtaking remote control information when there is a bypass route along the travel route of mobile body 20, and output the overtaking remote control information when there is no bypass route along the travel route of mobile body 20.

In addition, in this case, remote control information outputter 17 may, for example, temporarily suspend the output of overtaking remote control information when there is a bypass route along the travel route of mobile body 20. When the following mobile body travels along the same travel route as mobile body 20 even after mobile body 20 has passed the bypass route location, remote control information outputter 17 may release the temporary suspension on the overtaking remote control information and output the overtaking remote control information. When the following mobile body travels along a travel route different from the travel route of mobile body 20 after mobile body 20 has passed the bypass route location, remote control information outputter 17 may avoid releasing the temporary suspension on the overtaking remote control information and avoid outputting the overtaking remote control information.

In addition, when the traffic congestion occurring is a traffic congestion of the second case, remote control information outputter 17 may determine whether to output the overtaking remote control information to the outside, according to a time period during which the following mobile body is following.

In this case, remote control information outputter 17 may, for example, output the overtaking remote control information to the outside when the time period during which the following mobile body is following mobile body 20 is longer than a predetermined time period.

In addition, when the traffic congestion occurring is a traffic congestion of the second case, there is a case where: it is not necessary to remotely control mobile body 20 to enable the following mobile body to overtake mobile body 20; and instead, it is sufficient to simply cause mobile body 20 to automatically travel to the overtaking-permitted area.

In such a case, for example, remote control information outputter 17 may avoid outputting the overtaking remote control information, while controller 25 may cause mobile body 20 to automatically move to the overtaking-permitted area.

In this case, remote control information outputter 17 may, for example, output information indicating that mobile body 20 is caused to automatically move to the overtaking-permitted area, instead of outputting the overtaking remote control information to the outside.

Alternatively, in the case where, when the traffic congestion occurring is a traffic congestion of the second case, it is not necessary to remotely control mobile body 20 to enable the following mobile body to overtake mobile body 20, and instead it is sufficient to simply cause mobile body 20 to automatically travel to the overtaking-permitted area, remote control information outputter 17 may, for example, output, to the outside, information indicating making an inquiry to an operator as to whether to cause the mobile body to automatically travel to the overtaking-permitted area, instead of outputting the overtaking remote control information to the outside.

Returning to FIG. 1, the following continues to describe remote control system 1.

Remote control receiver 18 receives an operation performed by an operator for remotely controlling mobile body 20, and generates a remote control command to remotely control mobile body 20 based on the operation performed by the operator that has been received.

The operator can remotely control mobile body 20 to enable a following mobile body that is following mobile body 20 to overtake mobile body 20 when the overtaking remote control information is displayed on the display included in remote control information outputter 17.

The operator can also remotely control mobile body 20 so as to cause mobile body 20 to move according to a remote control request when the remote control request information is displayed on the display included in remote control information outputter 17.

When calculator 16 calculates a traffic congestion resolution timing, notification information outputter 13: generates notification information that is the information for notifying mobile body information including information related to the traffic congestion resolution timing that has been calculated by calculator 16, to the outside, and includes the mobile body information; and outputs the notification information that has been generated, to mobile body 20. In this manner, notification information outputter 13 notifies the mobile body information from mobile body 20 to the outside.

When remote control receiver 18 generates a remote control command, remote control command outputter 14 outputs, to mobile body 20, the remote control command that has been generated by remote control receiver 18.

### [Operations]

The following describes operations performed by remote control system 1 configured as above.

In remote control system 1, mobile body 20 performs following state information transmission processing, remote control request processing, and notification processing, and control center 10 performs first notification information output processing and remote control processing.

Hereinafter, the processing described above will be described in sequence with reference to the drawings.

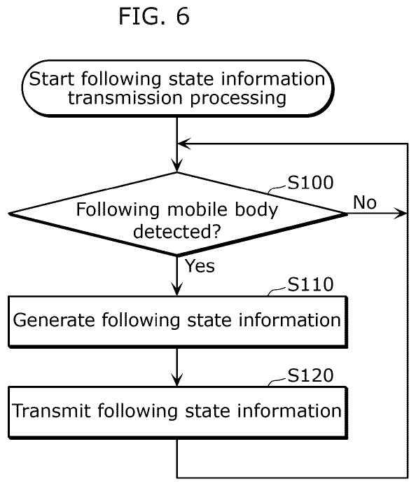

FIG. 6 is a flowchart illustrating the following state information transmission processing performed by mobile body 20.

The following state information transmission processing is started by, for example, activating mobile body 20.

As illustrated in FIG. 6, when the following state information transmission processing is started, following state information generator 21 waits until detector 22 detects a following mobile body that is following mobile body 20 (step S100: No). When detector 22 detects a following mobile body (step S100: Yes), following state information generator 21 generates following state information related to the following state of mobile body 20 (step S110).

When following state information generator 21 generates following state information, transmitter 24 transmits the following state information generated by following state information generator 21 to control center 10 (step S120).

When the processing of step S120 is completed, the following state information transmission processing proceeds again to the processing of step S100.

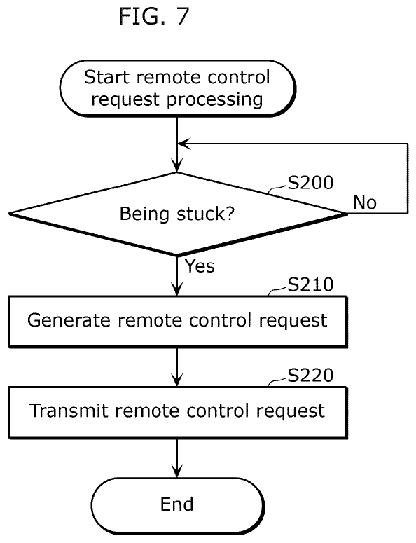

FIG. 7 is a flowchart illustrating the remote control request processing performed by mobile body 20.

The remote control request processing is started by, for example, controller 25 starting the control of autonomous movement of mobile body 20.

As illustrated in FIG. 7, when the remote control request processing is started, controller 25 continues controlling the autonomous movement of mobile body 20 until mobile body 20 gets stuck (step S200:
No). When mobile body 20 gets stuck (step S200: Yes), controller 25 generates a remote control request to request remote control of control center 10 (step S210).

When controller 25 generates the remote control request, transmitter 24 transmits the remote control request generated by controller 25 to control center 10 (step S220).

When the processing of step S220 is completed, the remote control request processing terminates.

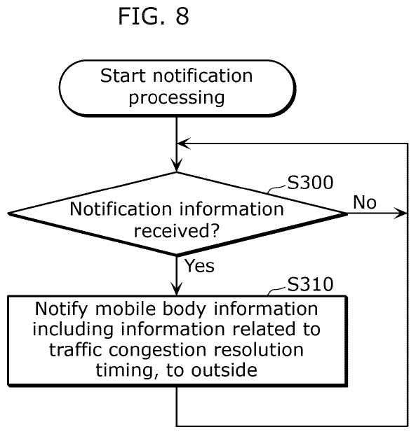

FIG. 8 is a flowchart illustrating the notification processing performed by mobile body 20.

The notification processing is started by, for example, activating mobile body 20.

As illustrated in FIG. 8, when the notification processing is started, notifying section 23 waits until receiver 26 receives notification information that is information (i) for notifying the mobile body information which includes information related to a traffic congestion resolution timing that is when a traffic congestion related to mobile body 20 is to be resolved, the outside, (i) transmitted from control center 10 (iii) and includes the mobile body information (step S300: No). When receiver 26 receives the notification information (step S300: Yes), notifying section 23 notifies the mobile body information included in the notification information that has been received, to the outside (Step S310).

When the processing of step S310 is completed, the notification processing proceeds again to the processing of step S300.

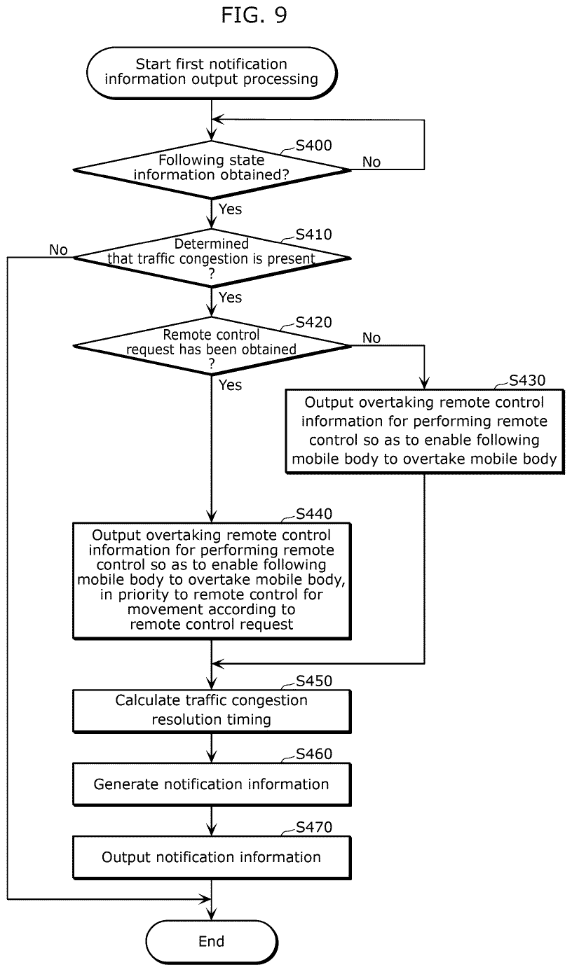

FIG. 9 is a flowchart illustrating the first notification information output processing performed by control center 10.

The first notification information output processing is started by, for example, performing an operation to start the first notification information output processing on control center 10.

As illustrated in FIG. 9, when the first notification information output processing is started, determiner 15 waits until following state information obtainer 11 obtains following state information transmitted from mobile body 20 (step S400: No). When following state information obtainer 11 obtains the following state information (step S400: Yes), determiner 15 determines whether a traffic congestion related to mobile body 20 is present, based on the following state information (step S410).

When determiner 15 determines that a traffic congestion related to mobile body 20 is present in the process of step S410 (step S410:
Yes), remote control information outputter 17 checks whether remote control request obtainer 12 has already obtained the remote control request that is output from mobile body 20 (step S420).

When remote control request obtainer 12 has not yet obtained the remote control request in the process of step S420, (step S420: No), remote control information outputter 17 outputs, to the outside, overtaking remote control information for remotely controlling mobile body 20 so as to enable the following mobile body that is following mobile body 20 to overtake mobile body 20 (step S430).

When remote control request obtainer 12 has already obtained the remote control request in the process of step S420 (step S420: Yes), remote control information outputter 17 outputs, to the outside, overtaking remote control information for remotely controlling mobile body 20 so as to enable the following mobile body that is following mobile body 20 to overtake mobile body 20, in priority to the remote control for causing mobile body 20 to move according to the remote control request (step S440).

When the processing of step S430 is completed, or when the processing of step S440 is completed, calculator 16 calculates a traffic congestion resolution timing that indicates when the traffic congestion related to mobile body 20 is to be resolved (step S450).

When calculator 16 calculates the traffic congestion resolution timing, calculator 16 generates notification information (step S460), and notification information outputter 13 outputs the notification information to mobile body 20 (step S470), thereby notifying the mobile body information from mobile body 20 to the outside.

When determiner 15 determines that no traffic congestion related to mobile body 20 is present in the processing of step S410 (step S410:
No), or when the processing of step S470 is completed, the first notification information output processing terminates.

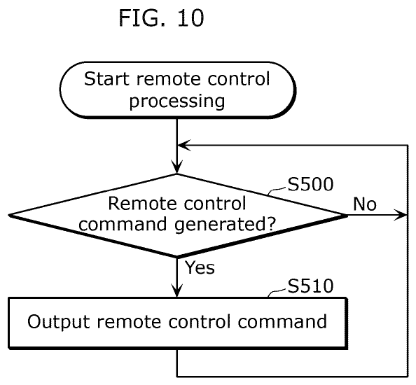

FIG. 10 is a flowchart illustrating the remote control processing performed by control center 10.

The remote control processing is started by, for example, performing an operation to start the remote control processing on control center 10.

As illustrated in FIG. 10, when the remote control processing is started, remote control command outputter 14 waits until remote control receiver 18 generates a remote control command to remotely control mobile body 20 (step S500: No). When remote control receiver 18 has generated the remote control command (step S500: Yes), remote control command outputter 14 outputs, to mobile body 20, the remote control command that has been generated by remote control receiver 18(step S510).

When the processing of step S510 is completed, the remote control processing proceeds again to the processing of step S500.

### [Consideration]

According to remote control system 1 configured as above, it is possible for a person around mobile body 20 to know when the traffic congestion will be resolved, using the notification information notified by mobile body 20. As a result, the person around mobile body 20 can take an appropriate action against the traffic congestion.

### Embodiment 2

The following describes a remote control system according to Embodiment 2 in which a portion of the configuration has been modified from remote control system 1 according to Embodiment 1.

The remote control system according to Embodiment 2 is an example of the system configured such that when a control center according to Embodiment 2 obtains a remote control request from mobile body 20, subsequently further obtains following state information from the same mobile body 20, and determines based on the following state information that a traffic congestion related to the same mobile body 20 is present, the remote control system outputs overtaking remote control information and/or remote control request information to the outside in a manner corresponding to the following state information that has been obtained.

Here, in regard to the remote control system according to Embodiment 2, the same reference numerals are assigned to structural components equivalent to the structural components of remote control system 1 as such structural components have already been described and the detailed description for such structural components will be omitted, and description will be provided with a focus on the differences from remote control system 1.

### [Configuration]

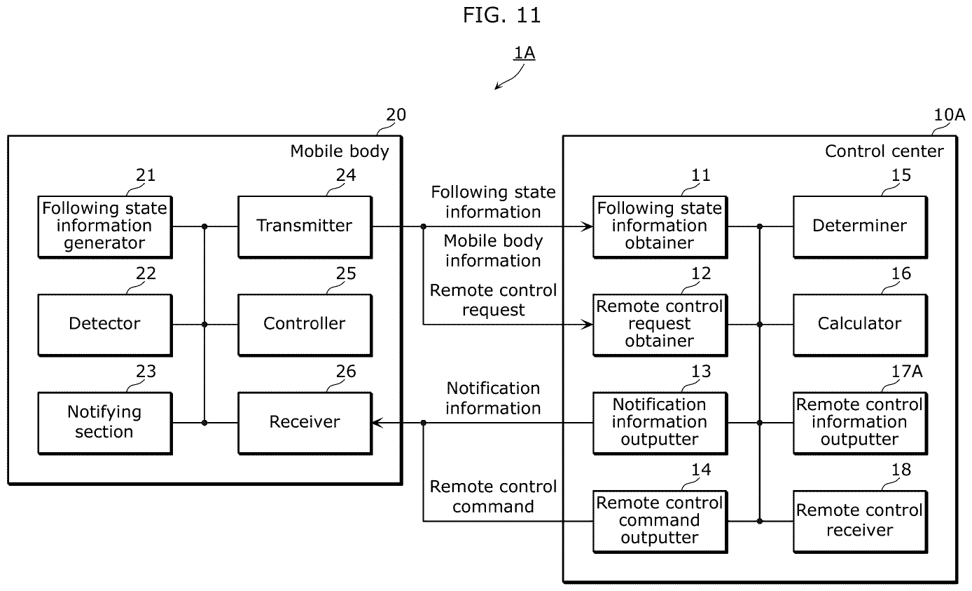

FIG. 11 s a block diagram illustrating a configuration of remote control system 1A according to Embodiment 2.

As illustrated in FIG. 11, remote control system 1A has a configuration in which control center 10 of remote control system 1 according to Embodiment 1 is changed to control center 10A. Here, control center 10A has a configuration in which remote control information outputter 17 of control center 10 is changed to remote control information outputter 17A.

When remote control request obtainer 12 obtains a remote control request from mobile body 20 and determiner 15 does not determine that a traffic congestion related to mobile body 20 is present, remote control information outputter 17A outputs, to the outside, remote control request information for remotely controlling mobile body 20 so as to cause mobile body 20 to move according to the remote control request.

In addition, when: remote control request obtainer 12 does not obtain a remote control request from mobile body 20; following state information obtainer 11 obtains following state information from mobile body 20; and determiner 15 determines, based on the following state information, that a traffic congestion related to mobile body 20 is present, remote control information outputter 17A outputs, to the outside, overtaking remote control information for remotely controlling mobile body 20 so as to enable a following mobile body that is following mobile body 20 to overtake mobile body 20.

In addition, when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present, remote control information outputter 17A outputs, to the outside, overtaking remote control information and/or remote control request information in a manner corresponding to the following state information.

For example, when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present, remote control information outputter 17A may, while outputting overtaking remote control information to the outside, inhibit outputting of remote control request information to the outside at least during the period in which the overtaking remote control information is output to the outside. At this time, remote control information outputter 17A may also output, for example, information indicating whether the information that is currently being output is the overtaking remote control information or the remote control request information.

In this manner, in the case where a traffic congestion is occurring when a remote control request has been issued, it is possible to inhibit an operator who remotely controls mobile body 20 from remotely controlling, based on the remote control request information, mobile body 20 so as to cause mobile body 20 to move according to the remote control request.

In this case, when the following state information includes information indicating a distance to the following mobile body, for example, remote control information outputter 17A may determine whether to inhibit outputting, to the outside, the remote control request information, based on the distance to the following mobile body.

Remote control information outputter 17A may, for example, compare a required distance for remote control based on the remote control request information (hereinafter also referred to as a “remote control request information required distance”) with a required distance for remote control based on the overtaking remote control information (hereinafter also referred to as a “overtaking remote control request information required distance”). When the remote control request information required distance is greater than the overtaking remote control information required distance, remote control information outputter 17A may inhibit outputting, to the outside, the remote control request information and output the overtaking remote control information to the outside.

In this manner, it is possible to cause the remote control to be completed with a shorter required distance.

Remote control information outputter 17A may, for example, inhibit the outputting of overtaking remote control information to the outside when the remote control request information required distance is less than or equal to the overtaking remote control request information required distance, and may instead output the remote control request information to the outside, and also output information indicating that the priority of the remote control operation performed on mobile body 20 in response to the remote control request information is increased.

In this manner, it is possible to start remote control based on the remote control request information as quickly as possible, without the need to perform remote control based on the overtaking remote control information.

In addition, when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present, remote control information outputter 17A may, for example, output, to the outside, information indicating making an inquiry to the operator as to whether to perform the remote control operation on mobile body 20 according to the remote control request information or to perform the remote control operation on mobile body 20 according to the overtaking remote control information.

In addition, when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present, if the following state information includes information indicating a type of the following mobile body, remote control information outputter 17A may, for example, output, to the outside, overtaking remote control information and/or remote control request information in a manner corresponding to the type of the following mobile body.

In this case, remote control information outputter 17A may, for example, inhibit outputting of the remote control request information to the outside, while outputting the overtaking remote control information to the outside. At this time, remote control information outputter 17A may, for example, output, to the outside, information indicating that the following mobile body is an emergency vehicle. In addition, at this time, even while the operator who remotely controls mobile body 20 is remotely controlling, based on remote control request information, mobile body 20 so as to cause mobile body 20 to move according to the remote control request, remote control information outputter 17A may, for example, inhibit outputting of the remote control request information to the outside, while outputting the overtaking remote control information to the outside.

In addition, in this case, when mobile body 20 is a robot moving within a factory and the following mobile body is another robot, for example, remote control information outputter 17A may inhibit outputting of the overtaking remote control information to the outside, while outputting the remote control request information to the outside.

In this manner, it is possible to operate robots in compliance with the factory rule that prohibits robots from overtaking other robots.

In addition, in this case, when mobile body 20 is a robot moving within a factory and the following mobile body is a customer, for example, remote control information outputter 17A may inhibit outputting of the remote control request information to the outside, while outputting the overtaking remote control information to the outside, and if the following mobile body is an employee, remote control information outputter 17A may inhibit outputting of the overtaking remote control information to the outside to the outside, while outputting the remote control request information to the outside At this time, remote control information outputter 17A may, for example, identify a person wearing the factory's uniform as an employee and a person not wearing the factory's uniform as a customer.

In this manner, it is possible to operate robots in compliance with the factory rule that prioritizes customer movement over employee movement.

In addition, in this case, in accordance with a predetermined rule concerning the following mobile body, remote control information outputter 17A may, for example: inhibit outputting of the remote control request information to the outside, while outputting the overtaking remote control information to the outside, if the following mobile body is a predetermined priority mobile body (e.g., a large vehicle) that is defined by the rule; and inhibit outputting of the overtaking remote control information to the outside, while outputting the remote control request information to the outside, if the following mobile body is a predetermined non-priority mobile body (e.g., a small vehicle) that is defined by the rule.

Here, the priority mobile body refers to a mobile body whose movement is prioritized over the movement of mobile body 20, and the non-priority mobile body refers to a mobile body whose movement is not prioritized over the movement of mobile body 20.

In this manner, for example, it is possible to pre-register operational rules for mobile body 20 such as prioritizing the movement of large vehicles over small vehicles.

As described above, for example, even when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present, remote control information outputter 17A may inhibit outputting of the overtaking remote control information, if the following mobile body is a mobile body that satisfies a predetermined condition.

In this manner, it is possible to inhibit an operator who remotely controls mobile body 20 from remotely controlling mobile body 20 so as to cause mobile body 20 to move according to the remote control request based on the remote control request information, when the following mobile body is a mobile body that satisfies the predetermined condition.

In addition, when outputting the overtaking remote control information and the remote control request information to the outside, remote control information outputter 17A may further output, to the outside, priority information indicating that the remote control according to the overtaking remote control information has a higher priority than the remote control according to the remote control request information.

In addition, when: remote control of mobile body 20 performed by the operator according to the overtaking remote control information that has been output has been ended; and remote control of mobile body 20 according to the remote control request information by the operator has not yet started, remote control information outputter 17A may output, to the outside, information indicating that remote control of mobile body 20 that is performed according to the remote control request information has not yet started. At this time, remote control information outputter 17A may, for example, output, to the outside, inquiry information indicating making an inquiry to the operator as to whether the remote control of mobile body 20 that is performed according to the remote control request information is to be performed prior to the remote control of another mobile body 20. In addition, at this time, remote control information outputter 17A may output, to the outside, information indicating that the remote control of mobile body 20 that is performed according to the remote control request information cannot be started until, for example, the following mobile body has completed overtaking mobile body 20. In addition, at this time, remote control information outputter 17A may, for example, inhibit outputting of the remote control request information to the outside until the following mobile body has completed overtaking mobile body 20, thereby preventing the operator from starting remote control of mobile body 20 that is performed according to the remote control request information. Remote control receiver 18 may, for example, inhibit receiving the operation by the operator for remotely controlling mobile body 20, thereby preventing the operator from starting remote control of mobile body 20 that is performed according to the remote control request information.

In addition, when: remote control request obtainer 12 obtains a remote control request from mobile body 20; subsequently following state information obtainer 11 further obtains following state information from mobile body 20; and determiner 15 determines based on the following state information that a traffic congestion related to mobile body 20 is present, and if remote control of mobile body 20 corresponding to the overtaking remote control information is being performed by the operator, remote control information outputter 17A may output, to the outside, while the remote control is being performed, information indicating that remote control of mobile body 20 corresponding to the remote control request needs to be performed after the remote control being performed is completed.

The operator can determine whether to perform the remote control of mobile body 20 that is performed according to the remote control request information prior to performing the remote control of another mobile body 20, by recognizing the inquiry information output from remote control information outputter 17A.

In addition, remote control information outputter 17A may, for example, output, to the outside, overtaking remote control information and/or remote control request information, in a manner corresponding to the progress of the remote control, when determiner 15 determines that a traffic congestion related to mobile body 20 is present, during a period in which the operator who remotely controls mobile body 20 is performing remote control on mobile body 20 based on the remote control request information to cause mobile body 20 to move according to the remote control request.

In this case, for example, when the progress of the remote control is exceeding a predetermined threshold, remote control information outputter 17A may inhibit outputting of the overtaking remote control information to the outside, while outputting the remote control request information to the outside. Conversely, when the progress of the remote control is not exceeding the threshold, remote control information outputter 17At may inhibit outputting of the remote control request information to the outside, while outputting the overtaking remote control information to the outside.

In addition, when: remote control request obtainer 12 obtains a remote control request from mobile body 20; subsequently following state information obtainer 11 further obtains following state information from mobile body 20; and determiner 15 determines based on the following state information that a traffic congestion related to mobile body 20 is present, remote control information outputter 17A may, for example, output, to the outside, overtaking remote control information and/or remote control request information in a manner corresponding to a result of comparing a moving distance of mobile body 20 necessary for the remote control of mobile body 20 that is performed according to the remote control request information (hereinafter also referred to as a “first moving distance”) with a moving distance of mobile body 20 necessary for the remote control of mobile body 20 that is performed according to the overtaking remote control information (hereinafter also referred to as a “second moving distance”).

In this case, for example, when the first moving distance is greater than the second moving distance, remote control information outputter 17A may inhibit outputting of the remote control request information to the outside, while outputting the overtaking remote control information to the outside.

Alternatively, in this case, for example, when the second moving distance is greater than or equal to the first moving distance, remote control information outputter 17A may: inhibit outputting of the overtaking remote control information to the outside, while outputting the remote control request information to the outside; and output, to the outside, information indicating that the priority of the remote control operation that is performed on mobile body 20 according to the remote control request information is increased.

### [Operations]

The following describes operations performed by remote control system 1A configured as above.

In remote control system 1A, control center 10A further performs second notification information output processing, inquiry processing, first determination processing, second determination processing, and third determination processing, in addition to the processing performed by control center 10 according to Embodiment 1.

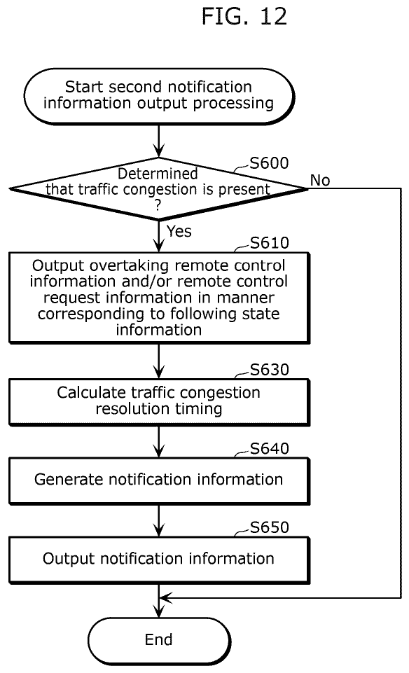

FIG. 12 is a flowchart illustrating the second notification information output processing performed by control center 10A.

The second notification information output processing is started by following state information obtainer 11 obtaining following state information subsequently to the obtaining of following state information by remote control request obtainer 12.

As illustrated in FIG. 12, when the second notification information output processing is started, determiner 15 determines whether a traffic congestion related to mobile body 20 is present, based on the following state information obtained by following state information obtainer 11 (step S600).

In the processing of step S600, when determiner 15 determines that a traffic congestion related to mobile body 20 is present (step S600: Yes), remote control information outputter 17A outputs, to the outside, overtaking remote control information and/or remote control request information in a manner corresponding to the following state information (step S610).

When the processing of step S610 is completed, calculator 16 calculates a traffic congestion resolution timing that indicates when the traffic congestion related to mobile body 20 is to be resolved (step S630).

When calculator 16 calculates the traffic congestion resolution timing, calculator 16 generates notification information (step S640), and notification information outputter 13 outputs the notification information to mobile body 20 (step S650).

When the processing of step S650 is completed, or when determiner 15 determines that no traffic congestion related to mobile body 20 is present in step S600 (step S600: No), the second notification information output processing terminates.

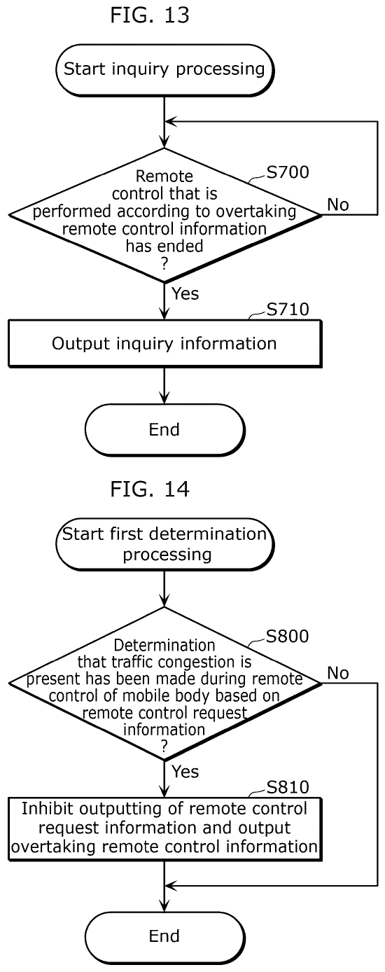

FIG. 13 is a flowchart illustrating the inquiry processing performed by control center 10A.

The inquiry processing is started by an operator starting remote control on mobile body 20 performed according to the overtaking remote control information output by remote control information outputter 17A, subsequent to the obtaining of a remote control request by remote control request obtainer 12.

As illustrated in FIG. 13, when the inquiry processing is started, remote control information outputter 17A waits until the remote control on mobile body 20 that is performed according to the overtaking remote control information ends (step S700: No). When the remote control on mobile body 20 that is performed according to the overtaking remote control information ends (step S700: Yes), remote control information outputter 17A outputs inquiry information indicating making an inquiry to the operator as to whether the remote control of mobile body 20 that is performed according to the remote control request information is to be performed prior to the remote control of another mobile body 20 (step S710).

When the processing of step s710 is completed, the inquiry processing terminates.

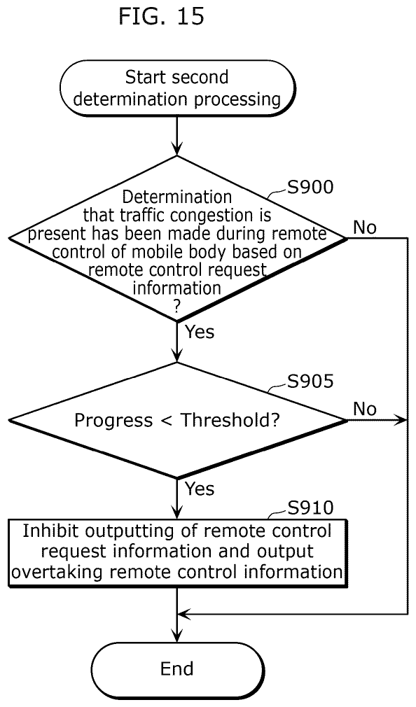

FIG. 14 and FIG. 15 are flowcharts illustrating the first determination processing and the second determination processing performed by control center 10A, respectively.

The first determination processing and the second determination processing are started by, when remote control information outputter 17A has output the remote control request information related to mobile body 20 to the outside, an operator, based on the remote control request information, starting remote control of mobile body 20 to cause mobile body 20 to move according to the remote control request, and subsequently determiner 15 determining that a traffic congestion related to mobile body 20 is present.

Control center 10A alternatively performs either the first determination processing or the second determination processing. Control center 10A may be alterably set in advance which of the first determination processing and the second determination processing to perform.

FIG. 14 is a flowchart illustrating the first determination processing performed by control center 10A.

As illustrated in FIG. 14, when the first determination processing is started, remote control information outputter 17A checks whether the determination that a traffic congestion related to mobile body 20 is present has been made by determiner 15 during a period in which the operator is remotely controlling, based on the remote control request information, mobile body 20 so as to cause mobile body 20 to move according to the remote control request (step S800).

In the processing of step S800, when the determination by determiner 15 that a traffic congestion is present has been made during a period in which the operator is performing the remote control of mobile body 20 so as to cause mobile body 20 to move according to the remote control request (step S800: Yes), remote control information outputter 17A inhibits the outputting of the remote control request information and outputs, to the outside, the overtaking remote control information instead of the remote control request information (Step S810). At this time, remote control information outputter 17A: may further output, to the outside, information indicating that the operator is to be caused to suspend handling the remote control request information and instead handle the overtaking remote control information; may output, to the outside, information indicating that the task has been changed; or may output, to the outside, information indicating the reason why the task has been changed.

In the processing of step S800, when the determination by determiner 15 that a traffic congestion is present has been made other than during a period in which the operator is performing the remote control of mobile body 20 so as to cause mobile body 20 to move according to the remote control request (step S800: No); that is, when the remote control is completed, and when the processing of step S810 is completed, the first determination processing terminates.

FIG. 15 is a flowchart illustrating the second determination processing performed by control center 10A.

In the second determination processing, the processing of step S900 and the processing of step S910 are identical to the processing of step S800 and the processing of step S810, respectively.

As such, the focus here is on explaining the processing of step S905.

As described in FIG. 15, in the processing of step S900, when the determination by determiner 15 that a traffic congestion is present has been made during a period in which the operator is performing the remote control of mobile body 20 so as to cause mobile body 20 to move according to the remote control request (step S900: Yes), remote control information outputter 17A checks whether the progress of the remote control is less than a predetermined threshold (Step S905).

In the processing of step S905, when the progress of the remote control is less than the predetermined threshold (step S905: Yes), the second determination processing proceeds to the processing of step S910.

In the processing of step S900, when the determination by determiner 15 that a traffic congestion is present has been made other than during a period in which the operator is performing the remote control of mobile body 20 so as to cause mobile body 20 to move according to the remote control request (step S900: No); that is, when the remote control is completed, when the progress of the remote control is not less than the predetermined threshold in the processing of step S905 (step S905: No), or when the processing of step S910 is completed, the second determination processing terminates.

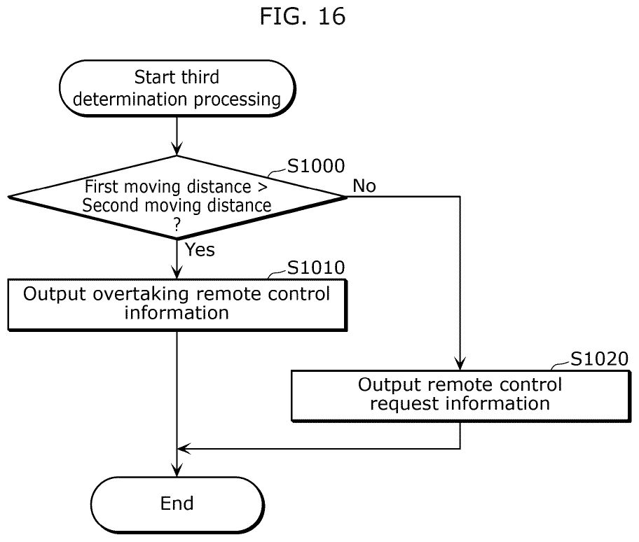

FIG. 16 is a flowchart illustrating the third determination processing performed by control center 10A.

The third determination processing is started when: remote control request obtainer 12 obtains a remote control request from mobile body 20; subsequently following state information obtainer 11 further obtains following state information from mobile body 20; and determiner 15 determines, based on the following state information, that a traffic congestion related to mobile body 20 is present.

As illustrated in FIG. 16, when the third determination processing is started, remote control information outputter 17A checks whether the first moving distance of mobile body 20 necessary for the remote control that is performed on mobile body 20 according to the remote control request information is longer than the second moving distance of mobile body 20 necessary for the remote control that is performed on mobile body 20 according to the overtaking remote control information (step S1000).

In the processing of step S1000, when the first moving distance is longer than the second moving distance (step S1000: Yes), remote control information outputter 17A outputs, to the outside, the overtaking remote control information (step S1010).

In the processing of step S1000, when the first moving distance is not longer than the second moving distance (step S1000: No), remote control information outputter 17A outputs, to the outside, the remote control request information (step S1020).

When the processing of step S1010 is completed or when the processing of step S1020 is completed, the third determination processing terminates.

### [Consideration]

According to remote control system 1A configured as above, it is possible for an operator who remotely controls mobile body 20 to remotely control mobile body 20 based on overtaking remote control information and/or remote control request information that has been output in a manner corresponding to following state information transmitted from mobile body 20. As a result, appropriate remote control according to the following state information is performed on mobile body 20.

### (Supplement)

As described above, the present disclosure has been described based on Embodiments 1 and Embodiment 2 as examples of the technique disclosed by the present application. However, the present disclosure is not limited to these embodiments. Various modifications of the present embodiment as well as embodiments resulting from combinations of structural components from different embodiments or variations that may be conceived by those skilled in the art are intended to be included within the scope of the one or more aspects of the present disclosure, so long as these do not depart from the essence of the present disclosure.

The generic or specific aspects of the present disclosure may be implemented by a system, a device, a method, an integrated circuit, a computer program, or a non-transitory computer-readable recording medium such as a compact disc read only memory (CD-ROM). Alternatively, the generic or specific aspects of the present invention may be implemented by any combination of systems, devices, methods, integrated circuits, computer programs, and non-transitory computer-readable recording media. For example, the present disclosure may be implemented as a program for causing a computer device to execute the processes performed by control center 10, control center 10A, mobile body 20, remote control system 1 and/or remote control system 1A.

### INDUSTRIAL APPLICABILITY

The present disclosure is broadly applicable to remote control systems, etc. that remotely control a mobile body that is autonomously movable and remotely controllable.

1. An information output method comprising:
obtaining following state information related to a following state of a mobile body that is autonomously movable and remotely controllable for movement;
calculating a traffic congestion resolution timing that indicates when a traffic congestion is to be resolved, the traffic congestion resolution timing being identified based on the following state information; and
notifying mobile body information to an outside from the mobile body, the mobile body information including information related to the traffic congestion resolution timing.

2. The information output method according to claim 1, further comprising:
obtaining a remote control request that requests remote control of the mobile body; and
when the remote control request is obtained in the obtaining of the remote control request, outputting overtaking remote control information to the outside, the overtaking remote control information being for remotely controlling the mobile body to enable a following mobile body that is following the mobile body to overtake the mobile body.

3. The information output method according to claim 2, wherein
the outputting further includes, when the remote control request is obtained in the obtaining of the remote control request, outputting remote control request information to the outside, the remote control request information being for remotely controlling the mobile body to cause the mobile body to move according to the remote control request.

4. The information output method according to claim 3, wherein
in the outputting, at least during a period in which the overtaking remote control information is being output, the outputting of the remote control request information is inhibited.

5. The information output method according to claim 3, wherein
in the outputting, when (i) the remote control request is obtained in the obtaining of the remote control request and (ii) the following mobile body satisfies a predetermined condition, the outputting of the overtaking remote control information is inhibited.

6. The information output method according to claim 3, wherein
the outputting further includes, when outputting both the overtaking remote control information and the remote control request information, outputting priority information to the outside, the priority information indicating that remote control according to the overtaking remote control information takes priority over remote control according to the remote control request information.

7. The information output method according to claim 3, wherein
in the outputting, when the following mobile body is an emergency vehicle, the outputting of the remote control request information is inhibited while the overtaking remote control information is output to the outside.

8. The information output method according to claim 3, wherein
in the outputting, when the following mobile body is a predetermined priority mobile body that is defined by a rule, the outputting of the remote control request information is inhibited.

9. The information output method according to claim 3, wherein
in the outputting, when the following mobile body is a predetermined non-priority mobile body that is defined by a rule, the outputting of the overtaking remote control information is inhibited.

10. The information output method according to claim 3, wherein
the outputting further includes, when (i) remote control of the mobile body that is performed in response to the outputting of the overtaking remote control information has ended and (ii) remote control of the mobile body that is performed in response to the outputting of the remote control request information has not yet started, outputting information indicating that the remote control of the mobile body that is performed in response to the outputting of the remote control request information has not yet started, to the outside.

11. The information output method according to claim 3, wherein
the outputting further includes, when (i) remote control of the mobile body that is performed in response to the outputting of the overtaking remote control information has ended and (ii) remote control of the mobile body that is performed in response to the outputting of the remote control request information has not yet started, outputting information indicating making an inquiry as to whether the remote control of the mobile body that is performed in response to the outputting of the remote control request information is to be performed prior to remote control of an other mobile body than the mobile body, to the outside.

12. The information output method according to claim 3, wherein
in the outputting, the outputting of the remote control request information is inhibited until remote control of the mobile body that is performed in response to the outputting of the overtaking remote control information is completed.

13. The information output method according to claim 3, further comprising:
determining whether a traffic congestion related to the mobile body is present, based on the following state information, wherein
the outputting further includes, when it is determined in the determining that the traffic congestion is present during a period in which remote control of the mobile body that is performed in response to the outputting of the remote control request information is being performed, outputting at least one of the overtaking remote control information or the remote control request information, to the outside, in a manner corresponding to progress of the remote control.

14. An information output device comprising:
a following state information obtainer that obtains following state information related to a following state of a mobile body that is autonomously movable and remotely controllable for movement;
a calculator that calculates a traffic congestion resolution timing that indicates when a traffic congestion is to be resolved, the traffic congestion resolution timing being identified based on the following state information; and
a notification information outputter that notifies mobile body information to an outside from the mobile body, the mobile body information including information indicating the traffic congestion resolution timing.

15. A non-transitory computer-readable recording medium having a program recorded thereon for causing a computer to perform information output processing, wherein
the information output processing includes:
obtaining following state information related to a following state of a mobile body that is autonomously movable and remotely controllable for movement;
calculating a traffic congestion resolution timing that indicates when a traffic congestion is to be resolved, the traffic congestion resolution timing being identified based on the following state information; and
notifying mobile body information to an outside from the mobile body, the mobile body information including information indicating the traffic congestion resolution timing.
